(19) United States
(12) Patent Application Publication
(10) Pub. No.: US 2024/0008645 A1
(43) Pub. Date: Jan. 11, 2024

(54) WALL-MOUNTED SHELF HANGER

(71) Applicant: Robert Bradford, Vacaville, CA (US)

(72) Inventor: Robert Bradford, Vacaville, CA (US)

(21) Appl. No.: 18/471,656

(22) Filed: Sep. 21, 2023

Related U.S. Application Data
(60) Provisional application No. 63/494,110, filed on Apr. 4, 2023.

(51) Int. Cl. A47B 96/06; A47B 96/14

(52) U.S. Cl. CPC A47B 96/06; A47B 96/1408

(57) ABSTRACT

A system of wall-mounted shelves is supported by at least two uprights, ideally of hollow molded plastic. The uprights are molded with screw holes for securing to a wall. The uprights are also molded with larger upright bracket holes for the insertion of tube brackets. Each upright bracket hole may be internally supported by a hollow cylindrical sleeve. The opposite end of each tube bracket serves as a shelf insert. A plurality of shelves, ideally of hollow molded plastic, each have at least two shelf bracket holes for receiving the shelf inserts. In an ideal embodiment, each tube bracket is bent at roughly a 15° angle between the upright insert and the shelf insert, so that the shelves slope downward toward the wall and prevent items from rolling forward off the shelves.

### 1. FIELD OF THE INVENTION

This invention is in the field of shelving, more specifically wall-mounted shelving.

### 2. BACKGROUND OF THE INVENTION

Recycled plastic self-assembled storage shelves are widely sold in big-box stores. However, they all stand on the floor.

### 4. SUMMARY OF THE INVENTION

The invention is a unique garage wall storage organizer for long-handled tools and other items. Hollow uprights are mounted separately to the wall with front and rear screw holes, ideally 16″ apart so they can be screwed into wall studs. Each upright has multiple upright bracket holes, which accommodate tube brackets. The tube brackets fit into shelf bracket holes on the rear surfaces of the shelves. In a preferred embodiment, the tube brackets are angled upward at approximately 15° so that round items do not roll forward off the shelves.

### 5. BRIEF DESCRIPTION OF THE DRAWINGS

FIG. 1 is an upper-left-front perspective view of the assembled wall-mounted shelf hanger.

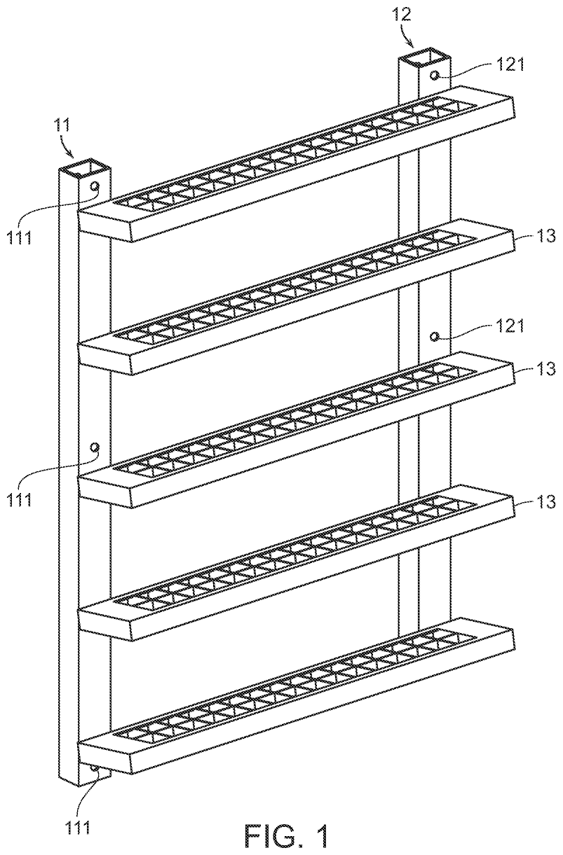

FIG. 2 is an upper-front perspective view of the assembled wall-mounted shelf hanger, intended to show the hollow interiors of the uprights.

FIG. 3 is an exploded version of FIG. 1 to show the tube brackets and the upright bracket holes.

FIG. 4 is an upper-left-rear perspective view of the shelves to show the shelf bracket holes.

### 6. DETAILED DESCRIPTION OF THE PREFERRED EMBODIMENTS

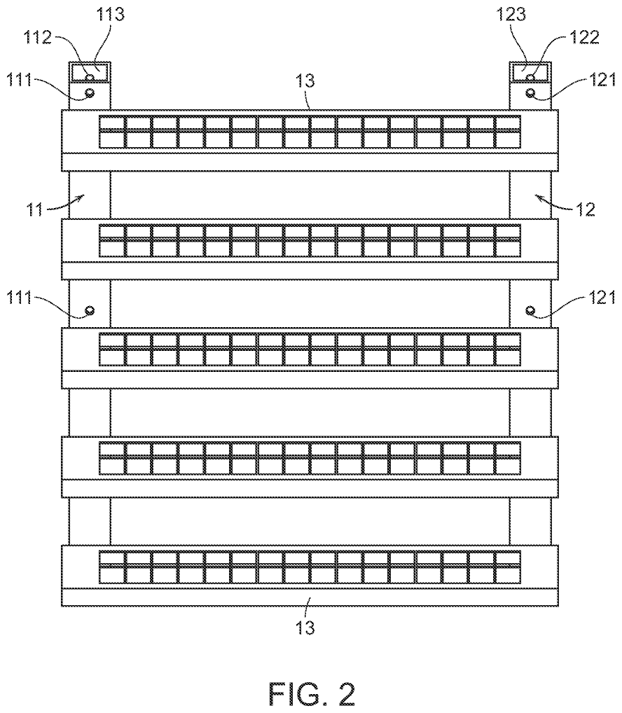

The wall-mounted shelf hanger is a wall-mounted garage organizer for long-handled and short-handled tools. It is ideally made of recycled plastic and is easily assembled without tools. A left upright 11 and a right upright 12 are designed for vertical mounting to a wall. The left upright has a left upright hollow interior 113 (see FIG. 2), a plurality of left upright front wall-mounting screw holes 111, and a plurality of left upright rear wall-mounting screw holes 112 aligned with the front wall-mounting screw holes. By identical construction, the right upright has a right upright hollow interior 123 (see FIG. 2), a plurality of right upright front wall-mounting screw holes 121, and a plurality of right upright rear wall-mounting screw holes 122 aligned with the front wall-mounting screw holes. It is intended for long wood screws to pass through each pair of front-and-rear wall-mounting screw holes to secure each upright to a wall. Ideally, each upright will be mounted to a stud, so that the uprights will be approximately 32″ apart in a house with standard construction. Since the uprights are hollow, they have open ends. It is desirable to use plastic caps to close these ends. The ideal plastic caps have dimensions of 1″ by 1.5″ by 3″. There are four plastic caps, one at the top and bottom of each hollow upright. They can act as colorful dust covers. Furthermore, the plastic caps are double-male ended. When two racks are in the vertical position on the wall, the plastic caps act as connectors to each other, combining two three-foot racks into one six-foot rack.

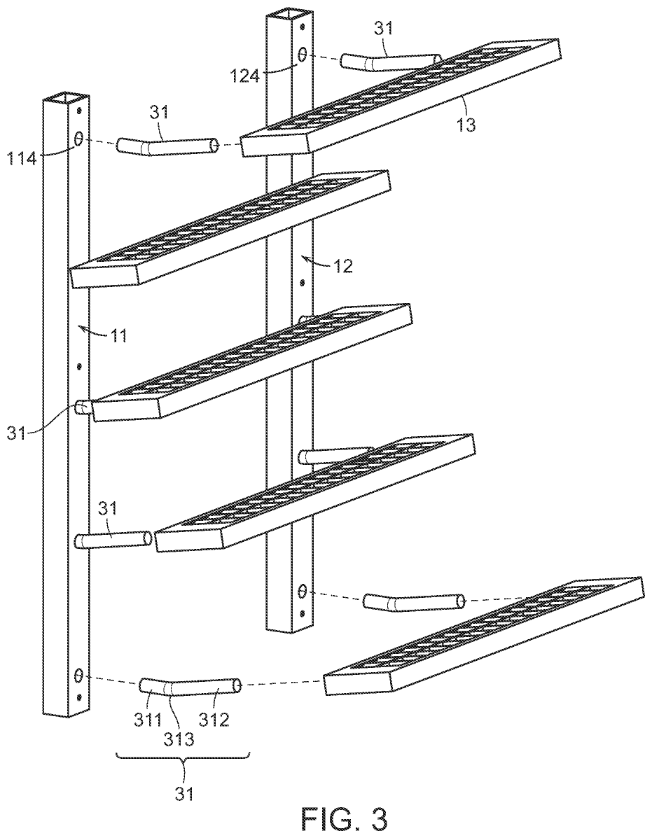

As seen best in FIG. 3, the left upright has a plurality of left upright bracket holes 114, ideally circular holes approximately one inch in diameter. By identical construction, the right upright has a plurality of right upright bracket holes 124, ideally circular holes approximately one inch in diameter, positioned level with the left upright bracket holes. An embodiment with five left upright bracket holes and five right upright bracket holes is shown in the figures.

A series of identical tube brackets 31 are provided for insertion into the left upright bracket holes 114 and the right upright bracket holes 124. Each tube bracket has an upright insert 311 on one end and a shelf insert 312 on the other end. Each upright insert 311 fits securely into a left upright bracket hole 114 or a right upright bracket hole 124. The upright insert 311 and the shelf insert 312 may be joined in a parallel, coaxial configuration, which would support shelves in standard horizontal position. In a preferred embodiment, the upright insert and the shelf insert are constructed non-parallel to form a bracket angle 313, i.e. a bend between the two ends. A bracket angle of approximately 15°+/−2° is ideal for mounting the shelves 13 at an inclined angle to prevent items from rolling forward off the shelves. Since the system is wall-mounted, rearward rolling brings items stably to rest against the wall.

For a maximally secure and motionless fit, a plurality of hollow cylindrical sleeves (not shown) are inserted or molded into the left upright bracket holes and right upright bracket holes, one hollow cylindrical sleeve per hole. Each hollow cylindrical sleeve will then accommodate one upright insert 311 with a press fit.

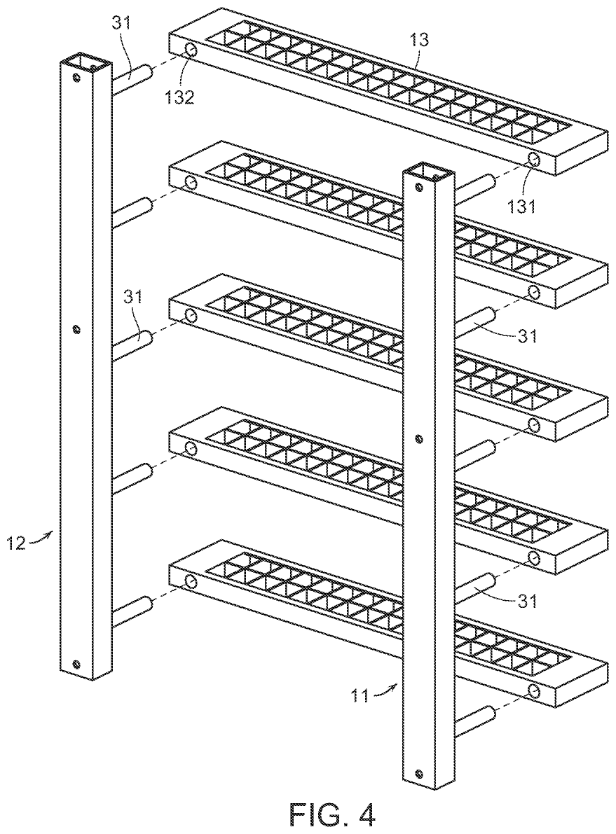

FIG. 4 shows the rear side of the shelves 13. Each shelf has a left shelf bracket hole 131 and a right shelf bracket hole 132. Each left shelf bracket hole and each right shelf bracket hole will accommodate one shelf insert 312 with a press fit. The left shelf bracket holes and the right shelf bracket holes are ideally molded cylindrically so that they do not require additional sleeves. In typical construction, each sleeve and upright insert 311 will be approximately two inches long, each shelf insert 312 will be about six inches long, and each left shelf bracket hole 131 and right shelf bracket hole 132 will be approximately six inches deep.

In a preferred embodiment, each tube has a plurality of molded ribs. As a realistic example, each tube bracket might have four molded ribs positioned equidistantly around the circumference, each molded fin being approximately 1/16″ to ⅛″ deep, running the length of the tube bracket. The molded ribs help the tube brackets to snap into the uprights and the shelves, thus locking them in tightly.

The reason for the upward-angled tubes is that when two tools are placed on them, each facing in the opposite direction, the tools will roll down toward the wall and stay in place on their edges, leaving more room for the tools below them against the wall. The uprights ideally stick out from the wall by two inches. The tools overlap the ends of the shelves.

The two plastic wall uprights are hollow, thus less weight and plastic and still have the strength to hold the ten tools that the shelf hanger will hold.

The homeowner can buy two racks for a six-foot, twenty tool garage tool organizer.

I claim a wall-mounted shelf hanger system comprising:

1. At least two identical uprights, each upright comprising
an upright hollow interior;
a plurality of upright front wall-mounting screw holes;
a plurality of upright rear wall-mounting screw holes aligned with the upright front wall-mounting screw holes;
a plurality of upright bracket holes;
a plurality of shelves, each shelf comprising at least two shelf bracket holes;
and a plurality of tube brackets, each tube bracket comprising an upright insert for inserting into an upright bracket hole;
and a shelf insert connected to the upright insert, for inserting into a shelf bracket hole.

2. The system of claim 1, wherein each tube bracket is bent at a bracket angle where the shelf insert is connected to the upright insert.

3. The system of claim 2, wherein each bracket angle is in the range of 13° to 17° inclusive.

4. The system of claim 1, further comprising hollow cylindrical sleeve supports for each upright bracket hole.

5. The system of claim 2, further comprising hollow cylindrical sleeve supports for each upright bracket hole.

6. The system of claim 3, further comprising hollow cylindrical sleeve supports for each upright bracket hole.
